(19) United States
(12) Patent Application Publication
(10) Pub. No.: US 2003/0088513 A1
(43) Pub. Date: May 8, 2003

(54) Billing system and method for network

(76) Inventors: Thomas J. Gritzmacher, Torrance, CA (US); John M. Palmer, San Gabriel, CA (US); Lance J. Gay, Torrance, CA (US); Timothy A. Yokote, Torrance, CA (US)

Correspondence Address: PATENT COUNSEL, TRW INC., S & E LAW DEPT., ONE SPACE PARK, BLDG. E2/6051, REDONDO BEACH, CA, 90278, US

(21) Appl. No.: 10/005,771

(22) Filed: Nov. 8, 2001

(51) Int. Cl. G06F 17/60

(52) U.S. Cl. 705/40

(57) ABSTRACT

A method and system are provided for billing usage over a network. This may include determining when a network interface is turned on and determining when the network interface is turned off. A time-based bill may be created based on when the network interface is turned on and when the network interface is turned off.

### BACKGROUND OF THE INVENTION

1. Field of the Invention

The present invention relates to a billing system and method. More particularly, the present invention relates to usage billing over secure encrypted networks.

2. Discussion of the Related Art

The Internet has become the gateway for connected users to access a plethora of information and interactive services. In addition, the Internet can provide users a mechanism for ordering various goods and services including theater/concert tickets and merchandise that will later be delivered by conventional transport means, and for ordering and receiving non-tangible goods that can be delivered in digital format directly over the Internet coincident with the transaction. This may include software, music, video and even electronic cash.

Billing for information and/or interactive services provided over the Internet, and for services or tangible or intangible goods ordered over the Internet and provided conventionally, or intangible goods delivered over the Internet, which are provided from a plurality of different sources may require the user to establish a financial relationship with each of the many different merchant Internet Service Providers (ISPs). In many instances, the relationship may be very fleeting if the user only wants to access information or an interactive service or order merchandise from an ISP once or twice, or only on a very occasional basis. Establishing such a relationship with a multitude of different merchant ISPs is inconvenient and may generally require furnishing the ISP with some type of payment mechanism such as a credit card number in order for the information, service, and/or goods to be provided via the Internet or other transport mechanism.

U.S. Pat. No. 5,905,736, the subject matter of which is incorporated herein by reference, discloses a method for billing a user for transactions conducted over the Internet. As disclosed therein, transactions are billed to a user by associating a user's identity with the IP address of the user's terminal that has been assigned to that terminal generally by an Internet Access Provider for a user's session on the Internet. A billing platform, connected on the Internet, may then be provided with the relationship between the user's identity and the IP address assigned to the user's terminal for the session. In response to a message from the merchant ISP that includes the IP address of the terminal conducting the transaction and the cost of the transaction, the billing platform adds the charges for the transaction to an account associated with the user. Such charges are then paid in accordance with a billing mechanism previously established between the user and the mechanism previously established between the user and the billing platform, such as to the user's bank credit card, debit account, merchant credit card, or telephone account.

It is desirable to implement a billing system and method for accessing information across a network.

### SUMMARY OF THE INVENTION

Embodiments of the present invention provide a method of billing usage over a network. This may include determining when a network interface is turned on and determining when the network interface is turned off. Information relating to a time-based bill may be stored based on when the network interface is turned on and when the network interface is turned off.

Desired information (such as video files, data files and/or audio files) may be obtained across the network while the network interface is on. This may involve encrypting the information, transmitting the encrypted information across the network, and decrypting the encrypted information at the receiving system.

A menu selection may be used to launch a selected application (such as for obtaining or transmitting the desired content). A connect packet may be transmitted from a client to a router device based on the selected application.

After turning on the network interface, a status packet may be transmitted from the router device to the client. A status of the router device may be updated in a state table.

In order to terminate the billing, a disconnect packet may be transmitted from the client to the router device. The network interface is thereby turned off and a status message is transmitted from the router device to the client. The status of the network interface may be updated based on the status message.

A call detail record may be transmitted from a client to a billing module based on the stored information. The call detail record may include information relating to at least one of a time, an Internet protocol address and a status.

Other objects, advantages and salient features of the invention will become apparent from the following detailed description taken in conjunction with the annexed drawings, which disclose preferred embodiments of the invention.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto.

The following represents brief descriptions of the drawings in which like reference numerals represent like elements and wherein:

FIG. 1 illustrates the architecture of a network having a billing server and network module according to an example embodiment of the present invention;

FIG. 2 is a block diagram illustrating the functional operation of the components according to an example embodiment of the present invention;

FIG. 3 is a flowchart showing a call setup method according to an example embodiment of the present invention; and

FIG. 4 is a flowchart showing a call disconnect method according to an example embodiment of the present invention.

### DETAILED DESCRIPTION OF PREFERRED EMBODIMENTS

Embodiments of the present invention will now be described with respect to example embodiments. Other embodiments and configurations are also within the scope of the present invention. In particular, embodiments of the present invention may provide a method of billing usage over a secure encrypted network. This may include determining when a network interface is turned on, determining when a network interface is turned off and storing information relating to a time-based bill based on when the network interface is turned on and when the network interface is turned off. A desired content (such as data, voice and/or video files, for example) may be obtained across the network when the network interface is on. This content may be encrypted for security reasons prior to transmission across the network. The content may be decrypted once received at the receiving system. A client may be subsequently billed based on the time that the network interface is on. Accordingly, embodiments of the present invention provide billing based on time usage. This may reduce the overhead for billing purposes

Embodiments of the present invention or portions of embodiments of the present invention may be provided within software loaded on computer systems. These computer systems may be coupled across a network and include a processing unit, at least one input device (such as a keyboard or mouse), at least one output device (such as a display) and at least one storage device. While embodiments may be described with respect to operations within computer systems, it is understood that embodiments of the present invention are equally applicable to other types of networking devices such as cellular phones and personal digital assistants.

The software may include a client menu interface component and a data collection server component. The client menu interface component may run on a client system such as a personal computer. The data collection server component (also hereafter referred to as a server or billing server) may run on a web server, for example. The data collection server component may also run on any of the networked devices including the client system and the content provider. The software may interact with other network devices so as to store information relating to a time-based bill of application usage.

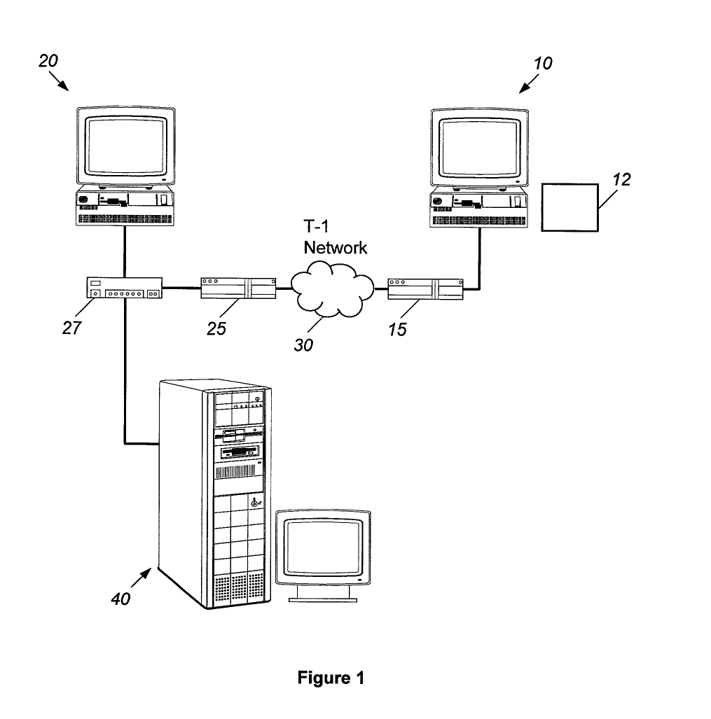

FIG. 1 illustrates an architecture of a network having a billing server and network module according to an example embodiment of the present invention. Other embodiments and configurations are also within the scope of the present invention. More particularly, FIG. 1 shows a computer system 10 (also called a client) coupled through a router 15 to a network 30. A computer system 20 is coupled through an Ethernet hub 27 and through a router 25 to the network 30. Other devices or methods of coupling each of the computer systems 10 and 20 to the network 30 are also equally applicable. That is, FIG. 1 merely shows one example of how computer systems may be coupled through the network 30. The network 30 may be, for example, a T-1 network, an ISDN network, a wireless communication network, or any other type of well-known network.

In accordance with embodiments of the present invention, a billing server 40 may also be coupled to the network 30. In the example shown in FIG. 1, the billing server 40 may be coupled through the Ethernet hub 27 and through the router 25 to the network 30. One skilled in the art would understand that the billing server 40 may be coupled through different means and devices to the network 30. In particular, the billing server 40 may be directly coupled to the computer system 10 or to the computer system 20. The billing server 40 may operate to store data regarding application usage by the computer system 10 when the computer system 10 turns on and/or off a network interface. In at least one embodiment, the network interface may correspond to a serial port on the router 15 that is coupled to the network 30. However, embodiments of the present invention are also applicable to interfaces on other ones of the network devices including but not limited to the router 25. Transactional information generated by the turning on and the turning off of the network interfaces may be used to generate information relating to a time-based bill.

FIG. 1 further shows a software network module 12 that includes a program of instructions to be executed by the computer system 10. The network module 12 may be provided on any number of different program storage means that are well known to one skilled in the art.

Embodiments of the present invention may perform transaction record collection in order to collect data regarding the usage of a specific application to obtain or transmit a desired content across the network 30. The computer system 10 (including the software network module 12) may provide dynamic provisioning of the network topology. The billing server 40 may accumulate information relating to a time-based bill of the application usage or the amount of time to obtain a desired content across the network 30. The client may maintain information for turning on the necessary network devices (such as the router 15) and the Internet protocol address of the billing server 40.

A menu interface may run on the computer system 10 to present a selection of applications available for use on the computer system 10. The user of the computer system 10 may make a menu selection and the client (i.e., the computer system 10 and/or the network module 12) may launch the selected application. At that time, the client may format and/or transmit a simple network management protocol (SNMP) packet (hereafter also called a connect packet) to the router 15. The software module 12 may record the time and date that the connect packet is sent to the router 15.

The router 15 receives the connect packet and turns on the appropriate network interface such as a serial port that is coupled to the network 30. This will allow the user to obtain the desired content (such as video, audio and/or data files) from the computer system 20 or to transmit the desired content to the computer system 20. The desired content may be obtained from the computer system 20 and downloaded across the network 30 in any of a number of well know manners. On the other hand, the desired content may be obtained from the computer system 10 and downloaded across the network 30 to the computer system 20. As one example, the desired content may be encrypted prior to transmission across the network 30. The receiving system may thereafter decrypt the content. U.S. patent application Ser. No. 09/536,110, filed Mar. 24, 2000, the subject matter of which is incorporated herein by reference, discloses a process and apparatus for managing visual content over a network. Embodiments of the present invention may be incorporated within the disclosed arrangements of that arrangement.

The router 15 may reply to the connect packet by formatting and/or returning a simple network management protocol (SNMP) packet (hereafter also called a status packet) back to the network module 12.

The computer system 10 (and the network module 12) maintains records regarding operations of network components. This may specifically relate to status and time of connection. For example, the network module 12 may update the status of the router 15 in a client's state table based on the status packet transmitted from the router 15 to the computer system 10. This may include the time and date the interface is turned on.

At any point, the network module 12 may communicate with the billing server 40 using a user datagram protocol packet (hereafter also called a call detail record), for example. Other methods of communicating between the network module 12 and the billing server 40 are also within the scope of the present invention. The call detail record may contain the recorded time, the Internet protocol address of a network interface, and the status of the network interface (such as the router 15). The billing server 40 receives the call detail record and stores the information in a database associated with the billing server 40. The billing server 40 may be located in any of numerous places including at the computer system 10 or at the computer system 20.

When the user at the computer system 10 is finished using an application or has completed obtaining the desired content, the network module 12 may present a choice to disconnect from the network 30 and stop the billing. The computer system 10 (in cooperation with the network module 12) may disconnect from the network 30 when the application is complete, when the computer system 10 determines the application is done and/or when specifically disconnected by the user such as by stroking a key or clicking on a disconnect icon.

When the user, application or system disconnects from the network 30, then the network module 12 may transmit a simple network management protocol (SNMP) packet (hereafter also called a disconnect packet) to the network device (such as the router 15). The network device (such as the router 15) receives the disconnect packet and turns off the appropriate network interface (such as the serial port of the router 15 coupled to the network 30). When the network interface is turned off, the user may not be able to obtain any more information across that interface until the interface is turned on. Thus, the billing may cease for that interface. The network device may reply to the disconnect packet by transmitting a status packet back to the network module 12. The status packet indicates that the network interface has been turned off.

Upon receiving the status packet indicating the interface has been turned off, the network module 12 may update the status of the network device (such as the router 15) in the state table stored at the computer system 10. This may include the time and date that the interface is turned off. The network module 12 may transmit a call detail record to the billing server 40. The call detail record may include the recorded time, the Internet protocol address of the network device and the status of the network device. The billing server 40 may receive the call detail record and store the information in a relational database.

Information from the call detail record may be presented (i.e., downloaded) through a web browser running on a personal computer such as the computer system 10 or the computer system 20. This information may be used to create a bill for the specific user. The user may request call detail records in a hypertext markup language format, for example. This process may be initiated on any machine with network connectivity to the billing server 40.

For a web browser client, a hypertext markup language page may be created with the date, time, device and length of time that the call was in operation. Additional information for call rates may be pulled from the database for presentation at the point where the hypertext markup language page is created.

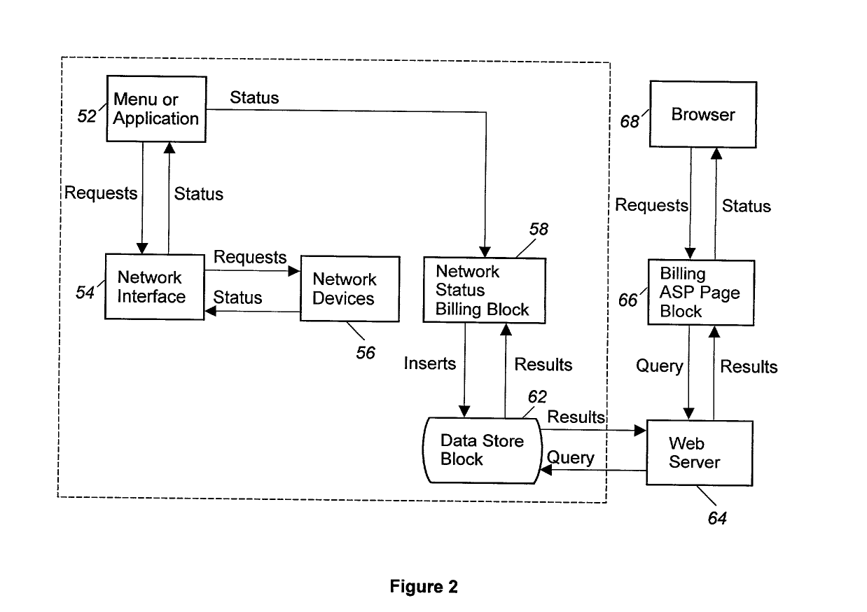

FIG. 2 is a block diagram illustrating the functional operation of the components shown in FIG. 1. This figure represents one example embodiment as other embodiments are also within the scope of the present invention. More particularly, FIG. 2 shows a menu or application 52, a network interface 54 and network devices 56. The menu or application 52 may correspond to the network module 12 (and the computer system 10), the network interface 54 may correspond to a serial port on the router 15 and the network devices 56 may correspond to the network 30 and other features such as the router 25. As shown, the menu or application 52 may communicate with the network interface 54 by various requests and status messages (also called packets). In turn, the network interface 54 may communicate with the network devices 56 by various requests and status messages.

FIG. 2 further shows a network status billing block 58 and a data store block 62. The network status billing block 58 and the data store block 62 may both correspond to components on the billing server 40. As shown, the menu or application 52 may communicate with the network status billing block 58 by transmitting a status message. This may correspond to the transmission of a call detail record to the billing server 40. The network status billing block 58 may communicate with the data store block 62 by insert messages and/or result messages (or packets). As such, information relating to a time-based bill may be stored in the data store block 62.

FIG. 2 still further shows a web server 64, a billing ASP page block 66 and a browser 68. These components may be provided on a single network apparatus or on different network apparatuses. The web server 64 may communicate with the data store block 62 by way of query messages and result messages to obtain information relating to the time-based bill. A page may be created by the billing ASP page block 66 by communicating with the web server 64 through query messages and result messages. Finally, this page may be accessed by a browser 68 through the use of request messages and status messages. In summary, FIG. 2 shows various functional aspects of how information relating to a time-based bill may be stored and how the bill may be generated.

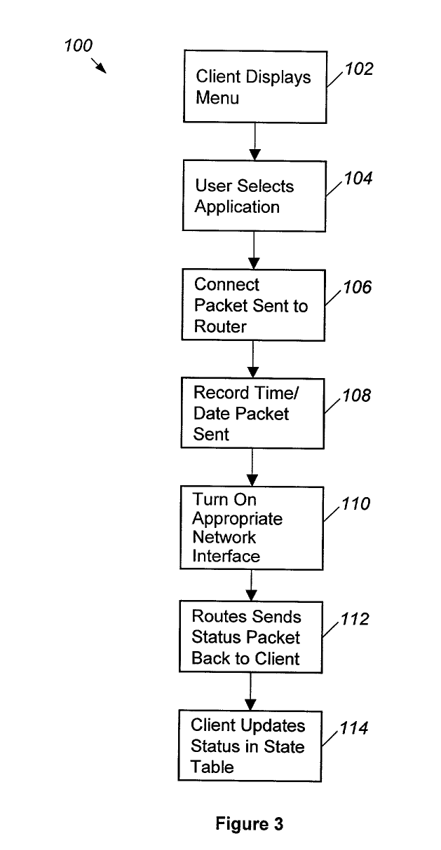

FIG. 3 illustrates a flowchart 100 showing a call setup method according to an example embodiment of the present invention. Other embodiments and orders of operation are also within the scope of the present invention. More particularly, FIG. 3 illustrates that the client displays a menu in block 102. This may correspond to the display of different applications that may be run on the computer system 10. In block 104, the user may select one of the displayed applications. In block 106, a connect packet may be sent to the appropriate router based on the selection of the user. This may correspond to the network module 12 sending a connect packet to the router 15. The time and date that the packet is sent may be recorded/stored in block 108. This may correspond to storing of the time and date in the computer system 10. In block 110, the appropriate network interface may be turned on. This may correspond to turning on the serial port of the router 15 coupled to the network 30. In block 112, the router 15 may send a status packet back to the client. This may correspond to the router 15 sending a status packet back to the computer system 10 (and more particularly to the network module 12). The client may update the status in a state table in block 114. Information relating to the time-based bill may be stored in the computer system 10 either when the connect packet is sent and/or when the router sends the status packet back to the computer system.

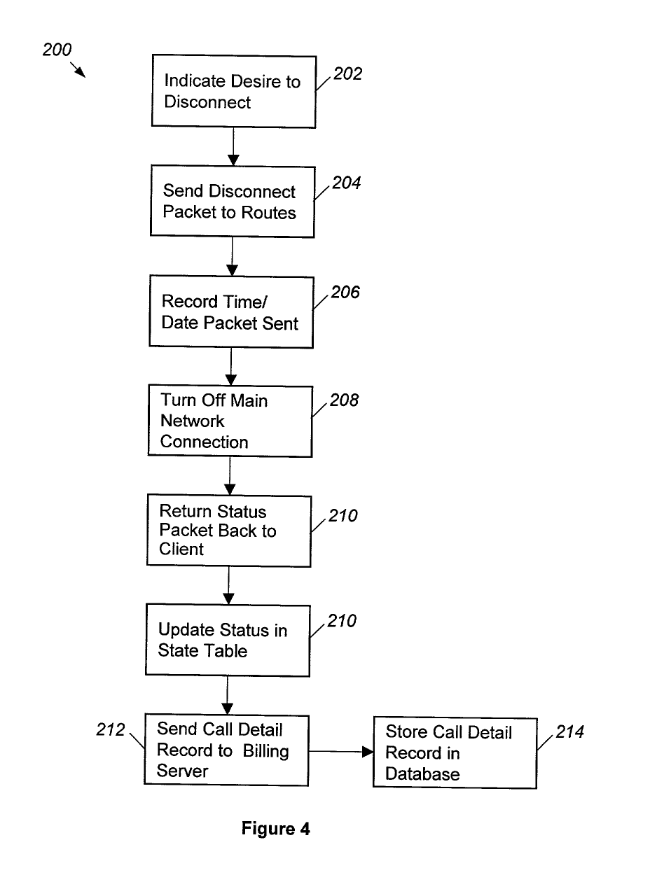

FIG. 4 illustrates a flowchart 200 showing a method of providing a call disconnect method according to an example embodiment of the present invention. Other embodiments and orders of operation are also within the scope of the present invention. More particularly, FIG. 4 shows that the computer system (either through the user directly or by the application itself) indicates a desire to disconnect in block 202. In block 204, a disconnect packet is sent to the appropriate router. This may correspond to a disconnect packet being sent from the network module 12 to the router 15. The time and date that the packet is sent may be recorded in block 206. Subsequently, the main network connection may be turned off in block 208. The main network connection may correspond to a serial port of the router 15 being turned off. A status packet may be returned back to the client in block 210. More specifically, a status packet may be sent from the router 15 back to the computer system 10 and to the network module 12. The status of the router 15 may be updated in the state table in block 210. Information relating to the time-based bill may be stored in the computer system 10 either when the disconnect packet is sent and/or when the router 15 sends the status packet back to the computer system 10. Subsequently, in block 212, a call detail record is sent to the billing server. This may correspond to a call detail record being sent to the billing module 40. The call detail record is stored in the database in block 214.

Accordingly, embodiments of the present invention provide a method of billing a client. This may involve connecting the client with a content provider of a desired content. The desired content may be obtained from the content provider and the client may be subsequently disconnected from the content provider. The method may involve determining the amount of time that the client is connected to the content provider. As such, a time-based application bill may be produced for Internet protocol networks.

Embodiments of the present invention have been described with respect to determining when a relevant network interface is turned on or off. Embodiments are similarly applicable to the determination of the approximate time that the interface is turned on or off, to the time information regarding the turning on or off is received at the system module 12, and/or to the time that packets are sent to the device to turn the interface on or off. Each of these relates to when the interface is turned off. Embodiments are also applicable to determining the amount of time (or approximate time) that the selected application is running.

Any reference in the above description to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the knowledge of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

Further, embodiments of the present invention or portions of embodiments of the present invention may be practiced as a software invention, implemented in the form of a machine-readable medium having stored thereon at least one sequence of instructions that, when executed, causes a machine to effect the invention. With respect to the term “machine”, such term should be construed broadly as encompassing all types of machines, e.g., a non-exhaustive listing including: computing machines, non-computing machines, communication machines, etc. Similarly, with respect to the term “machine-readable medium”, such term should be construed as encompassing a broad spectrum of mediums, e.g., a non-exhaustive listing including: magnetic medium (floppy disks, hard disks, magnetic tape, etc.), optical medium (CD-ROMs, DVD-ROMs, etc), etc.

A machine-readable medium includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A method of billing usage over a network, said method comprising:
determining when a network interface is turned on;
determining when said network interface is turned off; and
storing information relating to a time-based bill based on when the network interface is turned on and when the network interface is turned off.

2. The method of claim 1, further comprising obtaining desired information across said network while said network interface is on.

3. The method of claim 2, wherein obtaining said information comprises encrypting said information, transmitting said encrypted information across said network, and decrypting said encrypted information.

4. The method of claim 3, wherein said information relates to a video file.

5. The method of claim 1, further comprising launching an application based on a menu selection.

6. The method of claim 5, further comprising transmitting a connect packet from a client to a router device, said connect packet being based on said selected application.

7. The method of claim 6, wherein when said network interface is on, said method further comprises allowing access to a desired content.

8. The method of claim 6, further comprising transmitting a status packet from said router device to said client.

9. The method of claim 8, further comprising updating a status of said router device in a state table.

10. The method of claim 1, further comprising transmitting a call detail record from a client to a billing module based on said information relating to said time-based bill.

11. The method of claim 10, wherein said call detail record comprising information relating to at least one of a time, an Internet protocol address and a status.

12. The method of claim 1, further comprising transmitting a disconnect packet from a client to a router device.

13. The method of claim 12, further comprising transmitting a status packet from said router device to said client.

14. The method of claim 13, further comprising updating a status of said router device in a state table.

15. The method of claim 1, further comprising displaying call detail record information based on information relating to said time-based bill.

16. A method comprising:
connecting a client with a content provider of a desired content;
obtaining said desired content from said content provider;
disconnecting said client from said content provider; and
determining an amount of time said client is connected to said content provider.

17. The method of claim 16, wherein determining said amount of time comprises:
determining when a network interface to said content provider is turned on;
determining when said network interface to said content provider is turned off; and
storing information relating to a time-based bill based on when the network interface is turned on and when the network interface is turned off.

18. The method of claim 16, wherein obtaining said desired content comprises encrypting said desired content, transmitting said encrypted desired content from said content provider across a network and decrypting said encrypted desired content.

19. The method of claim 16, wherein connecting said client with said content provider comprises transmitting a connect packet from said client to a router device.

20. The method of claim 19, further comprising transmitting a status packet from said router device to said client.

21. The method of claim 20, further comprising updating a status of said router device in a state table.

22. The method of claim 16, further comprising transmitting a call detail record from said client to a billing module.

23. The method of claim 22, wherein said call detail record comprising information relating to at least one of a time, an Internet protocol address and a status.

24. The method of claim 16, wherein disconnecting said client from said content provider comprises transmitting a disconnect packet from said client to a router device.

25. The method of claim 24, wherein disconnecting said client further comprises transmitting a status packet from said router device to said client.

26. The method of claim 25, further comprising updating a status of said router device in a state table.

27. The method of claim 16, further comprising displaying call detail record information.

28. The method of claim 16, wherein said desired content relates to a video file.

29. A method of billing for access to a desired content across a network, said method comprising:
communicating with a network device to obtain access to said desired content;
obtaining said desired content across said network device;
communicating with said network device to terminate access to said desired content; and
storing information relating to said communicating with said network device.

30. The method of claim 29, wherein said stored information relates to when a network interface associated with said network device is turned on and when said network interface is turn off.

31. The method of claim 29, wherein obtaining said desired content comprises encrypting said desired content, transmitting said encrypted desired content across said network, and decrypting said encrypted desired content.

32. The method of claim 29, wherein said desired content relates to a video file.

33. The method of claim 29, wherein communicating with said network device to obtain access comprises transmitting a connect packet from a client to a router device.

34. The method of claim 29, further comprising transmitting a call detail record from a client to a billing module based on said stored information.

35. The method of claim 29, wherein communication with said network device to terminate access comprises transmitting a disconnect packet from a client to a router device.

36. A program storage device readable by machine, tangibly embodying a program of instructions executable by the machine to perform a method of billing usage over a network, said method comprising:
determining when a network interface is turned on;
determining when said network interface is turned off; and
storing information relating to a time-based bill based on when the network interface is turned on and when the network interface is turned off.

37. A computer system comprising at least one processing unit, at least one input device, at least one output device and at least one storage device, said storage device tangibly embodying a program of instructions executable by the processing unit to perform a method of billing usage over a network, said method comprising:
determining when a network interface is turned on;
determining when said network interface is turned off; and
storing information relating to a time-based bill based on when the network interface is turned on and when the network interface is turned off.
